(19) United States
(12) Patent Application Publication
(10) Pub. No.: US 2019/0281841 A1
(43) Pub. Date: Sep. 19, 2019

(54) GLUTEN FREE AND GRAIN FREE COMPOSITIONS OF FLOUR AND METHODS OF MAKING SAME

(71) Applicants: LORI WEISENBACH CORNETT, SIMSBURY, CT (US); KENNETH D. CORNETT, SIMSBURY, CT (US)

(72) Inventors: LORI WEISENBACH CORNETT, SIMSBURY, CT (US); KENNETH D. CORNETT, SIMSBURY, CT (US)

(21) Appl. No.: 16/214,080

(22) Filed: Dec. 9, 2018

Related U.S. Application Data
(60) Provisional application No. 62/642,156, filed on Mar. 13, 2018.

(51) Int. Cl. A21D 13/066; A21D 13/045; A21D 2/18; A21D 2/36; A21D 13/41

(52) U.S. Cl. CPC A21D 13/066; A21D 13/045; A21D 13/41; A21D 2/36; A21D 2/186

(57) ABSTRACT

Flour compositions that are free of gluten, grain, eggs and dairy are disclosed using a macronutrient level process and choosing gluten free and grain free ingredients that provide a macronutrient level as close to wheat flour as possible. Disclosed are gluten free and grain free flour products that closely match the macronutrient level of the wheat flour as well as other desirable attributes of a flour composition and products made therefrom.

### CROSS-REFERENCE TO RELATED APPLICATIONS

This application claims priority to U.S. provisional patent application Ser. No. 62/642,156, filed Mar. 13, 2018.

### BACKGROUND OF THE INVENTION

### Field of the Invention

Embodiments of the present disclosure generally relate to gluten free and grain free compositions and, more particularly, to flour compositions that are free of gluten, nuts, grains, dairy and egg. Further aspects of the present disclosure relate to a process and method for making flour compositions that are free of gluten, nuts, grains, dairy and egg.

### Description of the Related Art

Due to a wide variety of dietary issues food products are increasingly sought that made from flour that is free of objectionable ingredients such as gluten, nuts, grains, dairy and egg. Such flour is referred to herein as alternative flour. A typical goal in developing an alternative flour is to produce a finished product with a texture and taste similar to that which would have been produced with a wheat flour. With this goal in mind, a dough made with such an alternative flour can be handled and baked as traditional doughs made from wheat flour, wherein, when used for making pizza, no partial baking is required before topping it, nor is and special handling required. The replacement of wheat in baked products has been a notoriously difficult challenge. Centuries of baking processes have been optimized around the use of wheat-based flours containing gluten. Gluten provides attributes to doughs and products baked from the doughs such as nutrition, workability, moisture absorption, texture, flavor and other desirable attributes.

In an attempt to provide a gluten free composition, prior art U.S. Pat. No. 8,685,482 teaches a method of making gluten free products however the composition contains cheese and other ingredients, such as rice and corn, that may be objectional to certain people as described herein above. Another attempt in prior art to produce a gluten free composition for baked goods is disclosed in US Patent application 20100015317 also includes rice as an ingredient.

There are other prior art gluten free products that use legume flour such as Gillian's™ frozen pizza dough (https://gilliansfoodsglutenfree.com/pizza/) which lists the following ingredients: white rice flour, tapioca flour, water, soy flour, guar gum, egg whites, soy oil, yeast, salt, cane and sugar. It further lists the following nutritional attributes for a 50 gram serving: Protein 6 g (this total includes the egg whites); Carb 23 g; Fiber 1 g; Fat 5 g. Although soy flour is made from beans, the primary flour components are rice flour and tapioca. Gluten free pizza doughs and pastries often have starchy dense crumb to the dough because the flour that are used most often are based on rice flour and tapioca or potato starch. Rice and starch are typically chosen because it most resembles wheat flour in color, and because they add no flavor.

From a nutrition perspective, it is known in the prior art that wheat flour used to make pizza dough pizza typically is comprised of 12% protein. This type of flour is also referred to as “strong flour” or “high gluten flour”. As discussed herein above, taste is an important factor in the area of alternative flour products. Although an otherwise acceptable protein to carbohydrate ratio can be achieved using the various components found in known flours, (such as the “ancient” grains of sorghum, teff and amaranth) it has been found that mixtures of such known flours do not provide the taste profile required. It should also be noted that, with respect to flavor, the difficulty of discovering suitable alternative wheat flour substitutes is that wheat flour is not strongly flavored, thus any wheat flour substitute should not provide a lot of flavor to the dough.

White bean flour is known in the prior art but it is unusual. While bean flours are used in finished baked products, white bean flour is not typically found in baked products. Soy bean flour, black bean flour, and chick pea flours are the most common bean flours, though fava bean flour also is known. Most of the aforementioned flours have strong and distinct flavors that conflict with many baked products prepared therefrom.

Prior art studies have been done to test the addition of bean flours to wheat flours. The purpose of the addition is to increase the protein and mineral content of the wheat flours with the aim to serve populations in which a protein or mineral deficit exists, for example in under developed countries. One such study is found at www.emeraldinsight.com/doi/abs/10.1108/00346650510594912 Other additions, such as sesame seed flour, have been studied for the same purpose.

Rice flour is likely the most common gluten free flour present in most doughs or baked goods and is very often the first gluten free flour listed. Rice flour contains protein and starch and a small amount of fiber. However, it is not possible to get to the protein levels of all-purpose flour with rice (even when using brown rice) and products that contain grains may have deleterious effects on certain people.

Both tapioca and potato starch are common in gluten free foods, however tapioca is probably more common than potato. Both tapioca and potato starch are 100% starch, though there are subtle differences between them. Tapioca starch desiccates a bit better, and potato starch can be a bit gummy when wet. It is also known to introduce guar gum and xanthan gum with alternative flours to enhance texture and workability as they are typically used as a thickener in food products.

Therefore, there exists a need for flour composition that is free of ingredients that are harmful to certain individuals but that has the protein and carbohydrate profile of wheat flour and which has a neutral taste and workability, moisture absorption, texture, and other desirable attributes for use in the making of baked products similar to products made with wheat flour.

### SUMMARY OF THE INVENTION

A gluten free and grain free flour compositions are disclosed using a macronutrient level process and choosing gluten free and grain free ingredients that provide a macronutrient level as close to wheat flour as possible. Also disclosed are gluten free and grain free compositions that match the macronutrient level of the wheat flour as well as other desirable attributes of a flour composition.

1. Some embodiments of a gluten free flour composition disclosed comprise an amount of bean flour, an amount of potato starch, an amount of tapioca starch; and an amount of xanthan gum. In some embodiments the amount of bean flour is between 33% and 55%, the amount of potato starch is between 10% and 30%, the amount of tapioca starch is between 10% and 30%, and the amount of xanthan gum is between 0.5% and 2%. In an embodiment the amount of bean flour is approximately equal to 46%, the amount of potato starch is approximately equal to 26%, the amount of tapioca starch is approximately equal to 26%, and the amount of xanthan gum is approximately equal to 1.8%. In other embodiments a predetermined macronutrient level of the gluten free flour is chosen and is comprised of 9%-12% protein, 63%-78% carbohydrates, 11%-13% fiber, approximately 2% sugar and approximately 1% fat.

In certain other embodiments the gluten free flour composition also includes an amount of rice flour and the amount of bean flour is between 33% and 55%, the amount of potato starch is between 10% and 20%, the amount of tapioca starch is between 10% and 20%, the amount of xanthan gum is between 0.5% and 2% and the amount of rice flour is between 17% and 35%. Still other embodiments comprise white bean flour.

In yet other embodiments the gluten free flour composition further includes an amount of at least one of soy bean, chick pea, fava bean, sorghum, teff. amaranth, green pea, corn, cornmeal, corn starch, millet, oats, buckwheat, montina, almond, chestnut, coconut, flaxseed, salba, hemp, mesquite, quinoa, potato, and arrowroot.

Other embodiments are disclosed which include methods and processes to make such gluten free flour compositions and products.

### DETAILED DESCRIPTION

The flour compositions and products of the present disclosure are provided by starting from a macronutrient level and choosing gluten free, nut free and grain free ingredients that would provide a predetermined macronutrient level within a predetermined range of wheat flour. Heretofore, there exists no gluten free and grain free flour compositions that match the macronutrient level of wheat flour. The unique process of the present disclosure produces gluten free and grain free flour compositions that not only match the macronutrient levels of wheat flour but also meet neutral taste and workability requirements.

As used herein, the macronutrients of interest include protein, carbohydrates, fiber and fat. From a macronutrient perspective, the protein level of common wheat flour used in the art varies by type, ranging from 9% to 16% depending on what products are to be made with the flour. A typical wheat flour is comprised of 13.2% protein, 72% carbohydrates 10.7% fiber and 2.5% fat. As a comparison, the composition of a typical all-purpose flour is 10% protein, 76% carb, 3% fiber and 1% fat.

It should be appreciated by those skilled in the art that the FDA defines white bean as any mature bean of the species Phaseolus vulgaris, which includes navy beans, haricot beans, pearl haricot beans, Boston bean, white pea bean or pea bean. These varieties have substantially the same macronutrient levels as navy beans. Any of these beans as used in food, can be referred to as “white bean”. Black eyed peas are cowpeas, which while being similar in taste and nutrition are a different species. For instance, see www.fda.gov/iceci/compliancemanuals/compliancepolicyguidancemanual/ucm074591.htm. Some known suppliers of bean-based flours use different cultivars of this specie of white bean, which as will be described more fully herein after, make up part of the present disclosure. Certain gluten free and grain free embodiments of the present disclosure include a flour composition that comprises white bean flour, tapioca starch, potato starch, and xanthan gum. Certain gluten free flour compositions of the present disclosure further include adding rice flour to the composition but in doing so include a grain component.

It is an important to note as part of the present disclosure that, although the specific components themselves are important, the protein level relative to the carbohydrate level affects, and to a lesser extent the fiber content, the texture of products using flour compositions of the present disclosure.

It is known that alternative gluten free substances such as soy bean, chick pea, fava bean, sorghum, teff and amaranth flours are flours that are too strongly flavored as a direct substitute to wheat flour. Other alternative gluten free substances include green pea, corn, cornmeal, millet, oats, buckwheat, montina, almond, chestnut, coconut, flaxseed, salba, hemp, Mesquite, quinoa, potato, and arrowroot, among others. Such alternative gluten free substances can be high in protein and high in fiber, but the requisite protein and carbohydrate ratio may not be obtainable as a main ingredient because their strong flavors must be diluted with significant quantities starches such as tapioca, potato, corn or rice which adversely affect texture or workability. Rice flours are an exception to the aforementioned beans and grains because they contain some protein as well as starch (carbohydrate). Tapioca, potato and corn starches are essentially 100% flavorless carbohydrate. However, the protein level of rice flours (even those comprising brown rice flours) is too low to achieve the required protein/carbohydrate range of the present invention. Rice is however a grain and cannot therefore be used in a grain free composition of flour. It has been discovered that it is not possible to create an acceptable profile using only grains (rice, teff, amaranth) and have a flour that is neutral in flavor.

An embodiment of the present disclosure as described herein above employs a macronutrient level approach to arrive an optimum alternative flour composition. An embodiment of the present invention that matches or exceeds the macronutrient levels of wheat flour is arrived at by selecting the specific ingredients in the weight percent ranges shown in Table 1. In such an embodiment, on a percentage weight basis, the novel flour composition has the macronutrient levels in following ranges: 9-12% protein, 63-78% carbohydrates, 11-13% fiber, 2% sugar and 1% fat (rounding to the nearest integer) and in addition to these macronutrients, this particular embodiment also includes significant levels of minerals and vitamins. In one particular embodiment of the present invention the gluten free grain free flour composition is comprised of ingredients by percentage of weight as 46% white bean flour, 26.2% potato starch, 26.2% tapioca starch and 1.8% xanthan gum. This particular embodiment of the present disclosure has a nutrition profile shown in Table 2, for a 156 gram serving, which is better than some traditional wheat flours. There exists wheat flours with higher and lower levels of protein, a range from 11% protein (roughly equivalent to all-purpose flour) to 16% protein was tested as a part of the present disclosure. The best results were obtained with 12% protein. It is not possible to reach 12% protein with rice and tapioca as the alternative flour components unless psyllium husk powder is used. It is possible to get to produce an alternative flour having 12% protein if soy flour is added as a lesser component. However, soy flour has a distinct flavor and soy can be an allergen. Another embodiment of a flour composition of the present disclosure is 10% protein, 77% carbohydrate, 13% fiber, and 2% fat.

TABLE 1

| Ingredient | Range tested |
|---|---|
| Bean flour | 33%-55% |
| Potato starch | 10%-30% |
| Tapioca starch | 10%-30% |
| Xanthan gum | .5%-2% |

TABLE 2

| Gluten and Grain Free Embodiment | Amounts per 156 g serving | |
|---|---|---|
| Protein | 16 | g |
| Fiber | 13 | g |
| Sugar | 3 | g |
| Carbohydrates | 115 | g |
| Fat | 1 | g |
| Saturated fat | 0 | g |
| Polyunsaturated fat | 1 | g |
| Monounsaturated fat | 0 | g |
| Calories per serving | 514 | kcal |
| Calcium | 105 | mg |
| Cholesterol | 0 | |
| Sodium | 4 | mg |
| Potassium | 857 | mg |
| Iron | 4 | mg |

It has been discovered that these ratios can be achieved with rice flour and without rice flour and wherein baking performance of the embodiments is similar. Such a gluten free flour composition of the present invention that contains grains can be arrived at by selecting the specific ingredients in the weight percent ranges shown in Table 3. In one particular embodiment of the present invention the gluten free (but contianing grain) flour composition is comprised of ingredients by percentage of weight as 39% white bean flour, 17% rice flour, 17% potato starch, 17% tapioca starch and 1.8% xanthan gum. This particular embodiment of the present disclosure has a nutrition profile shown in Table 4, for a 250 g gram serving.

TABLE 3

| Ingredient | Range tested |
|---|---|
| Bean flour | 33%-55% |
| Rice flour | 17%-35% |
| Potato starch | 10%-20% |
| Tapioca starch | 10%-20% |
| Xanthan gum | .5%-2% |

TABLE 4

| Gluten Free Embodiment | Amounts per 250 g of flour | |
|---|---|---|
| Protein | 23 | g |
| Fiber | 20 | g |
| Sugar | 4 | g |
| Carbohydrates | 169 | g |
| Fat | 2 | g |
| Saturated fat | 0 | g |
| Polyunsaturated fat | 1 | g |
| Monounsaturated fat | 0 | g |
| Calories | 755 | kcal |
| Calcium | 144 | g |
| Cholesterol | 0 | |
| Sodium | 5 | mg |
| Potassium | 1161 | mg |
| Iron | 5 | mg |

Embodiments of the present disclosure include the alternative gluten free substances described herein above and can be added to the embodiments described set forth in Table 2 and Table 3 in amounts ranging from 1%-25% of additional weight so long as the macronutrient levels and taste profile are met.

It is known that higher mineral content can adversely affect gluten development in wheat flours. However, it has been discovered that the addition of bean flour increases the mineral content of embodiments of flour compositions of the present disclosure and an unexpected result has been discovered as part of the present disclosure wherein the higher mineral content of bean flours yields a mixture that behaves, in terms of texture and workability, as that of a wheat flour.

Examples of Products Comprised from Flour Compositions of the Present Disclosure.

As discussed herein before, pastas of the prior art made from gluten free flour lack workability characteristics and as such fall apart. Flour compositions of the present disclosure result in pasta products wherein the workability characteristics are much higher than prior art alternative flours which results in a pasta that is resilient and does not fall apart when cooked. Puff pastry is a product baked with flour which needs a dough that has extreme workability characteristics. As is known, puff pastry is a pastry made with layers of flour and water alternating with thin layers of butter. This laminated structure when heated at oven temperatures of 400 F and above results in a flaky, “puffed” structure. Heretofore, gluten free puff pastry, without the addition of eggs, has not been available because getting the structural integrity to create layers that will survive the cooking process had never been achieved. Traditional pizza dough is another popular product made from flour compositions and typically does not contain eggs, dairy or shortening. Pizza dough is typically stretched by hand or rolled to the desired thickness, topped with sauce, cheese and toppings and baked in a hot oven, preferably on a hot pizza stone or steel. Par-baking (partial baking) before topping is not desired and further should not be necessary. The finished pizza crust is desirably golden brown, having a mild delicious taste and should allow for the pizza to be prepared into slices to be eaten by hand. Pizza dough made from wheat alternative flour compositions of the present disclosure meets these requirements wherein the crumb of such pizza dough is similar to the crumb of a dough prepared from tradition gluten flour. A typical pizza crust made from flour compositions of the present disclosure can consist of, on a per serving basis, carbohydrates 18 g; fiber 2 g; fat 2 g; protein 2 g. According to information found at nutritiondata.self.com/facts/cereal-grains-and-pasta/5828/2 A typical pizza crust made from gluten flour can consist of, on a per serving basis of 100 g, carbohydrates 19 g; fiber 0.7 g; fat 0.5 g; protein 2.5 g

An important aspect of the present disclosure is the fiber content of the flour as it has been found to be important in creating the structure of crumb of certain doughs. Such doughs made from flour compositions of the present disclosure achieve a desirable dough texture without the addition of ingredients of prior art alternative flours that can be less desirable.

While the foregoing is directed to embodiments of the present invention, other and further embodiments of the invention may be devised without departing from the basic scope thereof, and the scope thereof is determined by the claims that follow.

What is claimed is:

1. A gluten free flour composition comprising:
an amount of bean flour;
an amount of potato starch;
an amount of tapioca starch; and
an amount of xanthan gum.

2. The gluten free flour composition of claim 1 wherein the amount of bean flour is between 33% and 55%, the amount of potato starch is between 10% and 30%, the amount of tapioca starch is between 10% and 30%, and the amount of xanthan gum is between 0.5% and 2%.

3. The gluten free flour composition of claim 1 wherein the amount of bean flour is approximately equal to 46%, the amount of potato starch is approximately equal to 26%, the amount of tapioca starch is approximately equal to 26%, and the amount of xanthan gum is approximately equal to 1.8%.

4. The gluten free flour composition of claim 1 further comprising a macronutrient level of 9%-12% protein, 63%-78% carbohydrates, 11%-13% fiber, approximately 2% sugar and approximately 1% fat.

5. The gluten free flour composition of claim 1 further comprising an amount of rice flour.

6. The gluten free flour composition of claim 5 wherein the amount of bean flour is between 33% and 55%, the amount of potato starch is between 10% and 20%, the amount of tapioca starch is between 10% and 20%, the amount of xanthan gum is between 0.5% and 2% and the amount of rice flour is between 17% and 35%.

7. The gluten free flour composition of claim 1 wherein the amount of bean flour is comprised of white bean flour.

8. The gluten free flour composition of claim 1 further comprising an amount of at least one of soy bean, chick pea, fava bean, sorghum, teff. amaranth, green pea, corn, cornmeal, corn starch, millet, oats, buckwheat, montina, almond, chestnut, coconut, flaxseed, salba, hemp, mesquite, quinoa, potato, and arrowroot.

9. A method of making a gluten free flour composition comprising:
determining a first macronutrient level of a gluten flour; and
selecting an amount of bean flour, an amount of potato starch, an amount of tapioca starch and an amount of xanthan gum to provide a second macronutrient level that is within a preselected range of to the first macronutrient level.

10. The method of claim 9 wherein the amount of bean flour is between 33% and 55%, the amount of potato starch is between 10% and 30%, the amount of tapioca starch is between 10% and 30% and the amount of xanthan gum is between 0.5% and 2%.

11. The method of claim 9 wherein the amount of bean flour is approximately equal to 46%, the amount of potato starch is approximately equal to 26%, the amount of tapioca starch is approximately equal to 26%, and the amount of xanthan gum is approximately equal to 1.9%.

12. The method of claim 9 wherein the second macronutrient level comprises 9%-12% protein, 63%-79% carbohydrates, 11%-13% fiber, approximately 2% sugar and approximately 1% fat.

13. The method of claim 9 further comprising selecting an amount of rice flour.

14. The method of claim 13 wherein the amount of bean flour is between 33% and 55%, the amount of potato starch is between 10% and 20%, the amount of tapioca starch is between 10% and 20%, the amount of xanthan gum is between 0.5% and 2% and the amount of rice flour is between 17% and 35%.

15. The method of claim 9 further comprising selecting an amount of at least one of soy bean, chick pea, fava bean, sorghum, teff. amaranth, green pea, corn, cornmeal, corn starch, millet, oats, buckwheat, montina, almond, chestnut, coconut, flaxseed, salba, hemp, mesquite, quinoa, potato, and arrowroot.

16. A gluten free flour product prepared by the process, comprising:
combining an amount of bean flour, an amount of potato starch, an amount of tapioca starch, and an amount of xanthan gum, to produce the gluten free flour product having a predetermined macronutrient level.

17. The process according to claim 16, wherein the amount of bean flour is between 33% and 55%, the amount of potato starch is between 10% and 30%, the amount of tapioca starch is between 10% and 30%, and the amount of xanthan gum is between 0.5% and 2%.

18. The process according to claim 16, wherein the amount of bean flour is approximately equal to 46%, the amount of potato starch is approximately equal to 26%, the amount of tapioca starch is approximately equal to 26%, and the amount of xanthan gum is approximately equal to 1.8%.

19. The process according to claim 16, wherein the predetermined macronutrient level is comprised of 9%-12% protein, 63%-78% carbohydrates, 11%-13% fiber, approximately 2% sugar and approximately 1% fat.

20. The process according to claim 16 further comprising an amount of rice flour.

21. The process according to claim 20 wherein the amount of bean flour is between 33% and 55%, the amount of potato starch is between 10% and 20%, the amount of tapioca starch is between 10% and 20%, the amount of xanthan gum is between 0.5% and 2% and the amount of rice flour is between 17% and 35%.

22. The process according to claim 16 wherein the amount of bean flour is comprised of white bean flour.

23. The process according to claim 16 further comprising an amount of at least one of soy bean, chick pea, fava bean, sorghum, teff. amaranth, green pea, corn, cornmeal, corn starch, millet, oats, buckwheat, montina, almond, chestnut, coconut, flaxseed, salba, hemp, mesquite, quinoa, potato, and arrowroot.
